(19) United States
(12) Patent Application Publication
(10) Pub. No.: US 2022/0072801 A1
(43) Pub. Date: Mar. 10, 2022

(54) PRINTER AND METHOD FOR ADAPTING PRINTING FLUID STRATEGY

(71) Applicant: Hewlett-Packard Development Company, L.P., Spring, TX (US)

(72) Inventors: Pol Fornos Martinez, Sant Cugat del Valles (ES); Ismael Fernandez Aymerich, Sant Cugat del Valles (ES); Arnau Codina Saborit, Sant Cugat del Valles (ES)

(73) Assignee: Hewlett-Packard Development Company, L.P., Spring, TX (US)

(21) Appl. No.: 17/417,962

(22) PCT Filed: Apr. 30, 2019
(86) PCT No.: PCT/US2019/029971

§ 371 Date: Jun. 24, 2021

(51) Int. Cl. B29C 64/393; B33Y 50/02

(52) U.S. Cl. CPC B29C 64/393; B33Y 50/02

(57) ABSTRACT

In accordance with the disclosure, there is provided, a method. The method may comprise performing a printing operation to produce a part based on a predetermined fluid strategy. The method may further comprise assessing part data, related to the printed part, for any inaccuracies, based on a printing operation input. The method may further comprise adapting the fluid strategy for a next printing operation, based on any identified inaccuracies.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Examples will now be described, by way of non-limiting example, with reference to the accompanying drawings, in which:

FIG. 1 is a flowchart of an example of a method for adapting a fluid strategy for printing;

FIG. 2 is a flowchart of an example of a further method for adapting a fluid strategy for printing;

FIG. 3 is a simplified schematic of an example of a device for adapting a fluid strategy for printing;

FIG. 4 is a simplified schematic of an example of a device for adapting a fluid strategy for printing; and

FIG. 5 is an example of a production plot for a print run.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects (printed parts) may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved using heat in a thermal fusing additive manufacturing operation. This may comprise directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up, coalesces and solidifies upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. In one example such a fusing agent may comprise an infra-red light absorber. In one example such a fusing agent may comprise a near infra-red light absorber. In one example such a fusing agent may comprise a visible light absorber. In one example such a fusing agent may comprise a UV light absorber. Examples of print agents comprising visible light enhancers are dye based coloured ink and pigment based coloured ink, such as inks commercially referred to as CE039A and CE042A available from HP Inc.

In other techniques, chemical solidification methods may be used in which a chemical solidification agent may be applied to the build material, and may fuse and solidify the build material without the application of heat.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed. According to one example, a suitable detailing agent may be a formulation commercially referred to as V1Q61A “HP detailing agent” available from HP Inc. A colouring agent, for example comprising a dye or colorant, may in some examples be used as a fusing agent or a coalescence modifier agent, and/or as a print agent to provide a particular colour for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

One form of layered additive manufacturing, may use a combined effect of fusing enhancers and other agents (such as detailing agents and colouring agents, etc.) deposited on a print material powder bed (such as a thermoplastic powder) to delimit the regions to be melted with a fusing energy source (such as infrared fusing radiation) for each layer to form a 3D part.

In such an additive manufacturing process, a layer of build material may be formed on a build platform. Fusing and detailing agents, as well as any other agents, may then be deposited in specific locations onto the formed layer. A fusing agent may be deposited on the formed layer where the build material is intended to fuse together to form the part. A detailing agent may be applied to modify the fusing (for example to create finer detail or smoother surfaces). The formed layer may then be exposed to the fusing energy which selectively fuses the powder substrate in the specific locations, based on where fusing agent is applied, to form the part.

Such printing techniques may be used to enhance the printing capacity in a production environment as this printing method allows multiple parts to be printed simultaneously. This printing method uses a high level of precision to provide part to part and build to build repeatability. Such a method is therefore particularly suited to printing where the same build job is printed repeatedly.

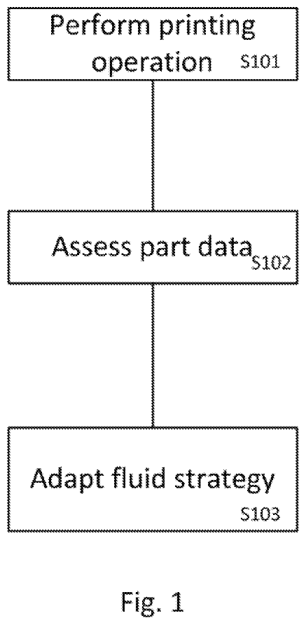

In some examples, as shown in FIG. 1, there is provided a method for improving printed part quality. The method may comprise performing S101 a printing operation to produce a part based on a predetermined or initial fluid strategy. A fluid strategy may define location and quantity of various fluids associated with the print are to be deposited. Such fluids may include fusing agents and detailing agents. After the part has been generated, the method may further comprise assessing S102 part data, related to the printed part, for any inaccuracies, based on a printing operation input. Inaccuracy of a part may be assessed against a printer input, such as a 3D model of the part to be printed. In some circumstances, the printed part may be different to the model. Such differences may include, for example, the dimensions of the part being different, the surface of the part having an unintended rugosity, and holes or internal features of the part being blocked or having not been formed properly. The part data may include data relating to measured or scanned dimensions of the part or internal or surface characteristics of the part. The method may further comprise adapting S103 the fluid strategy for a next printing operation, based on any identified inaccuracies.

When inaccuracies are identified, in the form of differences between the 3D model used to create the printing instructions and the corresponding printed part, changes may be made to the fluid strategy to correct these inaccuracies, for example by changing the amount of fusing agent and/or detailing agent deposited at any given location.

In some examples, fusing agents and detailing agents may be deposited independently onto build material through different nozzles. A fusing agent may assist in increasing the temperature of the build material, when fusing energy is applied to the layer of build material, at a specific location (where the fusing agent is deposited). A detailing agent may assist in reducing the temperature of the build material (comparatively) at a specific location, when fusing energy is applied to the layer of build material. Detailing agents may therefore be used to reduce the effect of thermal bleed and the amount of detailing agent may be increased to increase this effect.

In some examples, in practice, printers may have small printer to printer hardware differences. Such differences may lead to what may be called “cold or hot spots”. This means that locations within the build volume or area may experience lower or higher temperatures from printer to printer, which may lead to part quality defects. Such part quality defects may result in visible defects or inaccuracies on a printed part. The defects may then be assessed and the fluid strategy adapted for subsequent print runs, to reduce recurrence of defects. This may be performed iteratively with each print run to reduce waste resulting from producing defective parts.

In some examples, a print run may include at least one part to be printed. In some examples, a plurality of parts may be included in a print run, following a nesting process. In some examples, the plurality of parts may include many copies of the same part.

In some examples, the part data may be produced by scanning the printed part using a computer-aided visual inspection system. Such a system may include at least one camera. A computer-aided visual inspection system may provide accurate measurements of the printed part. The measurements may then be compared to those of the print instructions, to determine any differences. The computer-aided visual inspection system may output part data relating to a scanned, printed part. Part data may include data relating to at least one of dimensions of the part, surface characteristics and internal features.

A computer-aided visual inspection system may carry out a visual inspection of the part to assess whether the part is accurate or includes inaccuracies. Visual inaccuracies may include at least one of poor detail definition, unintended rugosity, “elephant skin”, unintended porosity and clogged holes or other internal features. Rugosity is when surface roughness is high. Elephant skin may occur when a part is printed colder than intended such that contractions appear inside the part, which may provide visible wrinkles on the part.

In some examples, the method may further comprise classifying inaccuracies based on the assessment of the part. Classifying inaccuracies may be carried out on the basis of remedial action need to ensure accuracy during the next or a future print of the part. In some examples, inaccuracies may be classified based on the visual inaccuracies listed above.

TABLE 1

| Part issue: | Diagnosis: | Remedial action: |
|---|---|---|
| Thermal bleed | Too high temperature | Increase amount of |
| Rugosity | | detailing agent either |
| Poor detail | | inside or outside part |
| definition | | |
| Elephant skin | Too low temperature | Decrease amount of |
| Porosity | | detailing agent at location |
| | | of issue |
| Clogged holes | Insufficient detailing | Increase amount of |
| | agent | detailing agent inside holes |

In some examples, the fluid strategy may be adapted for areas of a part determined to be inaccurate. Areas or parts, where the part is accurate, may reuse the same fluid strategy for repeat prints of the same area or part.

For example, each part or print run may include a tolerance level, inaccuracies exceeding the tolerance level are deemed to need correction. Inaccuracies not exceeding the tolerance level are deemed sufficiently accurate so as to not need correction. This form of local modification may improve the part quality for parts previously deemed inaccurate or containing defects, while leaving the rest of the build unaffected.

In some examples, adapting the fluid strategy may include at least one of changing an amount fusing agent and detailing agent to be deposited at specific locations in a build volume. The changes to the amounts may be made based on the amounts used in the initial fluid strategy. For larger inaccuracies, fusing agent levels may be adapted. For smaller inaccuracies, detailing agent levels may be adapted. A detailing agent may be added to modify the fusing for the purpose of creating fine detail and smooth surfaces. Therefore, achieving the correct level of detailing agent at a specific position on a part improves the finish and accuracy at that position. In some examples, a fluid strategy may be a liquid strategy for printing.

According to some examples, it is possible to improve the print quality of printed parts by adapting a fluid strategy for printing a part based on a previous print for the same part. Such adaptation may include changing an amount of fusing, detailing or other agents, where a part from the earlier print is deemed inaccurate or of poor quality. Subsequent prints of the “same” part, but having the adapted fluid strategy, may also assessed for accuracy, such that the fluid strategy can again be adapted for later prints.

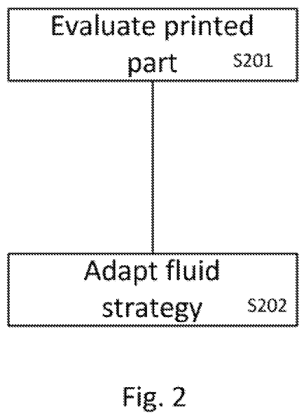

In some examples, as shown in FIG. 2, there is provided a further method. The method may comprise evaluating S201 a part, printed by an additive manufacturing process and according to a predefined fluid strategy, for inaccuracies based on part data, relating to the printed part, and a printing operation input. The method may further comprise, based on the evaluation, adapting S202 the fluid strategy for a next print run.

Evaluation of the part may be carried out automatically following the print run. The evaluation may include performing a visual inspection of the part or some or all parts of a print run. Part data may be printed object property data and may be presented in a similar format to printing operation inputs, to improve ease of comparison.

In some examples, the evaluating may comprise inspecting the part using a computer-aided visual inspection system. Such a system may include at least one camera. The computer-aided visual inspection system may feed results of the evaluation, which may include suggested remedial action to address any inaccuracies, back so that the fluid strategy for subsequent prints of the same part(s) may be changed to avoid recurrence of the identified inaccuracy.

In some examples, the printing operation input may include at least one of dimensions of the part and surface characteristics. In some examples, the printing operation input may include printing instructions related to an object model for the part to be printed. Dimensions of a printed part may be compared with the dimensions indicated in the print instructions, in order to evaluate whether an inaccuracy exists. Surface characteristics may include detail definition and finish. Further printing operation inputs may include instructions for holes or other internal features in the part.

In some examples, inaccuracies may be evaluated based on identifying differences between the printing operation input and part data including data related to the dimensions of the printed part. The original object model, when presented as printing instructions for printing the part may be geometrically modified to account for normal shrinkage or deformation which may occur during printing. Such regular, predictable changes may be accounted for before adapting the fluid strategy.

In some examples, adapting the fluid strategy may include increasing or decreasing an amount of detailing agent to be deposited at specific locations onto a layer of print material. Changing the amount of detailing agent at specific locations or regions on the print material, to produce the part or a surface of the part may affect the temperature of the part at that region or improve the specificity with which the print material is fused together. For example, the amount of detailing agent may be increased at a location in the build volume where the temperature is too high. Too high a temperature at a location may lead to thermal bleed, rugosity or poor detail definition. In another example, if a too low amount of detailing agent is present at a location, the amount of detailing agent may be increased. Not enough detailing agent may lead to part quality issues such as clogged holes. In another example, an amount of detailing agent may be reduced at a location in the build volume where the temperature is too low. Too low a temperature at a location may lead to part quality issues such as elephant skin or porosity.

In some examples, as shown in FIG. 3, there is provided a device 10. The device 10 may comprise a print evaluator 100 to evaluate a printed part, following a print run to produce the printed part according to a predefined fluid strategy, for inaccuracies based on a printing operation input. The device may further comprise a controller 110 to, based on the evaluation, adapt the fluid strategy for a next print run.

The device 10 may be a printer or a control device for a printer. In other examples, the device 10 may be external to a printer for printing the part. The print evaluator 100 may be a processor or other evaluation device for assessing whether a printed part is deemed accurate according to a set of criteria. The controller 110 may be a processor or other control device for controlling a fluid strategy that is applied to a print operation.

In some examples, the print evaluator 100 may comprise a computer-aided visual inspection device to carry out a visual inspection of the printed part. The computer-aided visual inspection device may include at least one camera or other sensor for detecting the dimensions and surface characteristics of a printed part.

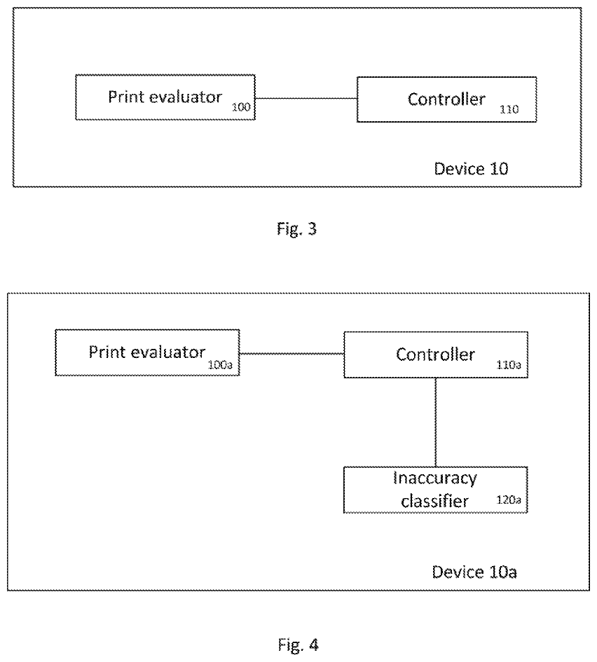

In some examples, as shown in FIG. 4, the device 10a may further comprise an inaccuracy classifier 120a to classify inaccuracies based on the visual inspection and output to the controller instructions for adapting the fluid strategy. Device 10a, print evaluator 100a and controller 110a of FIG. 4 correspond to device 10, print evaluator 100 and controller 110 of FIG. 3. The inaccuracy classifier 120a may be a processor or other classification device, and may include a transmitter or output device for outputting instructions to the controller.

In some examples, there is provided a program. The program which, when executed on a computer, may cause the computer to carry out a process. The process may comprise receiving part evaluation data including data relating to a visual appearance of a part, printed by an additive manufacturing process. The process may further comprise comparing the part evaluation data with part printing data for printing the part. The process may further comprise assessing accuracy of the part, based on the comparison. When the assessment indicates inaccuracy in the part, the process may comprise outputting an adapted fluid strategy, for printing a part, based on the assessment.

In some examples, when the assessment indicates that the part is accurate, the process may comprise outputting a fluid strategy corresponding to the fluid strategy for the printed part.

In further examples, there is provided a program which, when executed on a computer or processor, causes the computer or processor to carry out any of the methods described above.

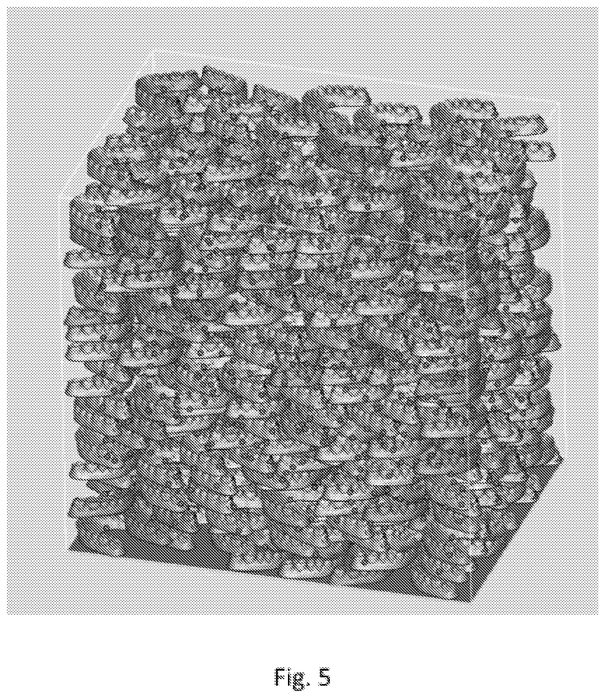

In some examples, as shown in FIG. 5, a print run may comprise a nesting process in which parts to be printed are arranged within the print area. In some examples, the nesting processing may involve arranging the parts to be printed in such a way so as to optimise the use of space, to print a large number of parts in a single print run. FIG. 5 shows an example of how parts to be printed may be arranged in order to obtain as many parts as possible, taking into account restrictions, such as proximity of a part to any adjacent parts.

The printing operation input may comprise data representing at least a portion (in some examples, a slice) of a part to be printed by an additive manufacturing apparatus by fusing a build material. The printing operation input may be described as object model data and may for example comprise a Computer Aided Design (CAD) model, and/or may for example be a STereoLithographic (STL) data file. In some examples, the printing operation input may represent the part (object) or part portion as a plurality of sub-volumes, wherein each sub-volume represents a region of the part which is individually addressable in part printing (generation). In some examples herein, the sub-volumes may be referred to as voxels, i.e. three-dimensional pixels.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
performing a printing operation to produce a part based on a predetermined fluid strategy;
assessing part data, related to the printed part, for any inaccuracies, based on a printing operation input; and
adapting the fluid strategy for a next printing operation, based on any identified inaccuracies.

2. The method of claim 1, wherein
the part data is produced by scanning the printed part using a computer-aided visual inspection system.

3. The method of claim 1, further comprising:
classifying inaccuracies based on the assessment.

4. The method of claim 1, wherein
the fluid strategy is adapted for areas of a part determined to be inaccurate.

5. The method of claim 1, wherein
adapting the fluid strategy includes at least one of changing, when compared to an initial fluid strategy, an amount fusing agent and detailing agent to be deposited at specific locations in a build volume onto a layer of build material.

6. A method comprising:
evaluating a part, printed by an additive manufacturing process, following a print run to produce the part according to a fluid strategy, for inaccuracies based on part data, relating to the printed part, and a printing operation input; and
based on the evaluation, adapting the fluid strategy for a next print run.

7. The method of claim 6, wherein
the evaluating comprises inspecting the part using a computer-aided visual inspection system.

8. The method of claim 6, wherein
the printing operation input includes at least one of dimensions of the part and surface characteristics.

9. The method of claim 6, wherein
inaccuracies are evaluated based on identifying differences between the printing operation input and the part data.

10. The method of claim 6, wherein
adapting the fluid strategy includes increasing or decreasing an amount of detailing agent to be deposited at specific locations onto a layer of build material.

11. A device comprising:
a print evaluator to evaluate a printed part, following a print run to produce the printed part according to a fluid strategy, for inaccuracies based on part data, relating to the printed part, and a printing operation input; and
a controller to, based on the evaluation, adapt the fluid strategy for a next print run.

12. The device of claim 11, wherein
the print evaluator comprises:
a computer-aided visual inspection device to carry out a visual inspection of the printed part.

13. The device of claim 12, further comprising:
an inaccuracy classifier to classify inaccuracies based on the visual inspection and output to the controller instructions for adapting the fluid strategy.

14. The device of claim 11, wherein to evaluate the printed part, the print evaluator is to:
receive part evaluation data including data relating to a visual appearance of the printed part;
compare the part evaluation data with part printing data for printing the part; and
assess accuracy of the part, based on the comparison, wherein the controller adapts fluid strategy for the next print run based on the assessed accuracy.

15. The device of claim 14, wherein when the assessment indicates that the part is accurate, the controller is to output a fluid strategy corresponding to the fluid strategy for the printed part.
